(19) United States
(12) Patent Application Publication
(10) Pub. No.: US 2023/0259539 A1
(43) Pub. Date: Aug. 17, 2023

(54) SYSTEM AND METHOD FOR AUTOMATICALLY EXTRACTING AND VISUALIZING TOPICS AND INFORMATION FROM LARGE UNSTRUCTURED TEXT DATABASE

(71) Applicant: THE GOVERNING COUNCIL OF THE UNIVERSITY OF TORONTO, Toronto (CA)

(72) Inventors: Kevin COURSE, Toronto (CA); Trefor W. EVANS, Toronto (CA); Prasanth B. NAIR, Richmond Hill (CA)

(21) Appl. No.: 17/669,943

(22) Filed: Feb. 11, 2022

(51) Int. Cl. G06F 16/332; G06F 16/35; G06F 16/33

(52) U.S. Cl. CPC G06F 16/3328; G06F 16/355; G06F 16/3347

(57) ABSTRACT

A system and method for automatically extracting and visualizing topics and information from a database of unstructured text documents. The method including: mapping each text document in the database into a latent vector in a latent space using a trained machine learning model; receiving a query from a user; mapping the query to the latent space; determining a predetermined set of text documents in the document database nearest to the query using a similarity metric on the latent vectors of each document; using a trained clustering machine learning model, determining cluster labels for the query and the set of the documents nearest to the query, the clustering labels representative of topics; and displaying a visualization of the query, the documents nearest to the query, and the cluster labels.

### TECHNICAL FIELD

The following relates generally to semantic search and exploration of document databases and more specifically to a system and method for automatically extracting and visualizing topics and information from large unstructured text databases.

### BACKGROUND

Effective modern business operations rely in a large part on the ability to analyze the contents of large corpuses of text documents. For instance, when beginning a task, it is a common practice for employees to parse their organization's corpus, archive or library of text documents, standards, guides, reports and communication channels to find relevant content as a basis for their current project. Simultaneously, management will spend time analyzing the contents of previous project documents, lessons learnt, and various communication channels, with the goal of identifying potential collaborators and gaps in team expertise. Unfortunately, present approaches for analyzing contents of text documents are generally primitive, with most relying on filtering and basic search. These existing tools provide only limited assistance to content analysis. For instance, tools to search or filter content are only helpful to the extent that the user has some idea of what sorts of things to search for or what aspects to filter in or out. This often requires a significant background review to find relevant topics in the corpus or to rely on their previous knowledge about the topics, which might result in missing important topics that were not previously known to the user.

To make the problem worse, an extremely large number of documents are generated everyday as the internet and electronic devices are becoming increasingly ubiquitous throughout the business world. This leads to information overload based on an overwhelming number of items to consider and a lack of prior knowledge about the domain of a document. As a result, the process of corpus content analysis remains frustratingly manual, tedious, and time consuming.

### SUMMARY

In an aspect, a computer-implemented method for automatically extracting and visualizing topics and information from a database of text documents is provided, the method comprising: mapping each text document in the database into a latent vector in a latent space using a machine learning model; receiving a query from a user; mapping the query to the latent space; retrieving a predetermined number of text documents in the document database nearest to the query using a similarity metric on the latent vectors of each document; using a clustering machine learning model, determining cluster labels for the query and the set of the documents nearest to the query, the clustering labels representative of topics; and displaying a visualization of the query, the documents nearest to the query, and the cluster labels.

In a particular case of the method, each text document in the database is mapped into a latent vector using a transformer-based machine learning model and taking an aggregate statistic of a hidden state for each word.

In another case of the method, the aggregate is given by any statistic of the latent vectors.

In yet another case of the method, the number of clusters is determined using frequentist or Bayesian techniques.

In yet another case of the method, the number of clusters is received from the user.

In yet another case of the method, the topics are determined from the cluster labels using latent Dirichlet allocation or non-negative matrix factorization.

In yet another case of the method, topics are extracted over only a subset of the document database, the subset being a particular number of documents nearest to the query.

In yet another case of the method, each document in the database has an author or team associated with the document, the method further comprising determining an aggregate measure of the latent vectors of the documents associated with the author or team.

In yet another case of the method, the visualization is of an adjacency matrix with the documents nearest to the query are centered around the query.

In yet another case of the method, the method further comprises receiving a further query from the user in regard to one of the documents in the visualization, replacing the query with the further query and reperforming the method from the mapping step.

In another aspect, a system for automatically extracting and visualizing topics and information from a database of unstructured text documents is provided, the system comprising one or more processors in communication with a data storage, the one or more processors configured to execute: an interface module to receive a query from a user; a mapping module to map each text document in the database into a latent vector in a latent space using a trained machine learning model, and to map the query to the latent space; a search module to determine a predetermined set of text documents in the document database nearest to the query using a similarity metric on the latent vectors of each document; a clustering module to use a trained clustering machine learning model to determine cluster labels for the query and the set of the documents nearest to the query, the clustering labels representative of topics; and an output module to display a visualization of the query, the documents nearest to the query, and the cluster labels.

In a particular case of the system, each text document in the database is mapped into a latent vector using a transformer-based machine learning model and taking an aggregate of a hidden state for each word.

In yet another case of the system, the aggregate is given by any statistic of the latent vectors.

In yet another case of the system, the number of clusters is determined using frequentist or Bayesian techniques.

In yet another case of the system, the number of clusters is received from the user.

In yet another case of the system, the topics are determined from the cluster labels using latent Dirichlet allocation or non-negative matrix factorization.

In yet another case of the system, the topics are extracted over only a subset of the document database, the subset being a particular number of documents nearest to the query.

In yet another case of the system, each document in the database has an author or team associated with the document, and wherein the mapping module further determines an aggregate measure of the latent vectors of the documents associated with the author or team.

In yet another case of the system, the visualization is an adjacency matrix with the documents nearest to the query are centered around the query.

In yet another case of the system, the interface module receives a further query from the user of one of the documents in the visualization, the system configured to regenerate the visualization on the basis of the further query.

These and other aspects are contemplated and described herein. It will be appreciated that the foregoing summary sets out representative aspects of embodiments to assist skilled readers in understanding the following detailed description.

### DESCRIPTION OF THE DRAWINGS

A greater understanding of the embodiments will be had with reference to the Figures, in which:

FIG. 1 is a schematic diagram of a system for automatically extracting and visualizing topics and information from large unstructured text databases, in accordance with an embodiment;

FIG. 2 is a schematic diagram showing the system of FIG. 1 and an exemplary operating environment;

FIG. 3 is flowchart for an example input query that is used to determine an adjacency matrix, clusters, and topics given a document database, in accordance with the system of FIG. 1;

FIG. 4 is an example user interface for visualizing a generated adjacency matrix, clusters, and learned set of topics, in accordance with the system of FIG. 1; and

FIG. 5 is a flowchart of a method for automatically extracting and visualizing topics and information from large unstructured text databases, in accordance with an embodiment.

FIG. 6 includes two example visualizations that can be used to identify relationships and trends directly from the document database.

### DETAILED DESCRIPTION

Embodiments will now be described with reference to the figures. For simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

Any module, unit, component, server, computer, terminal or device exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the device or accessible or connectable thereto. Any application or module herein described may be implemented using computer readable/executable instructions that may be stored or otherwise held by such computer readable media.

Latent topic modeling is a machine learning based task of identifying topics that best describe a set of documents. As would be appreciated by a person of skill, within the field of machine learning for natural language modeling, performing latent topic modeling on an extremely large corpus of documents made up of disparate topics is both computationally expensive and often times unfruitful in terms of topic discovery. For example, topic modeling in this context tends to extract only the most high-level topics in the corpus. Advantageously, the present embodiments remedy these issues by, for example, forcing interaction with the database of documents through a search done in the latent space generated by a machine learning model. As described herein, keywords can be directly transformed into a latent representation, document titles can return a latent representation of the document they represent, and author names can return a statistic (for example, a mean) of the latent representations of all documents written by the author. Given this latent representation, a small number of documents (for example, 100) nearest this query in the latent space are returned. This small number of documents can then be automatically clustered, and topics can be generated for each cluster on-the-fly using a latent topic model. Due to the relatively small size of each cluster, this approach is substantially more efficient in the discovery of topics. Moreover, because each topic within each cluster contains similar content due to their proximity in the latent space, the discovered topics tend to be far more granular and meaningful than if latent topic modeling was performed on the entire document database.

Embodiments of the present disclosure provide approaches for automatically extracting and visualizing topics and insights from large unstructured text databases for use in, for example, design, project management, and organization leadership. The embodiments can be applied to various applications and sectors, examples of which include:
allowing users to find similar projects and documents based on topic similarity;
finding potential collaborators within an organization based on an algorithmically generated set of skills that employees have demonstrated on previous projects;
identifying vanishing skills within an organization;
identifying organizational trends;
and the like.

The present embodiments are especially beneficial for organizations with massive digital document libraries. The present embodiments can combine generative machine learning models for dimensionality reduction and topic discovery with specialized user interfaces to allow users to explore their organizations document libraries more deeply than they otherwise could.

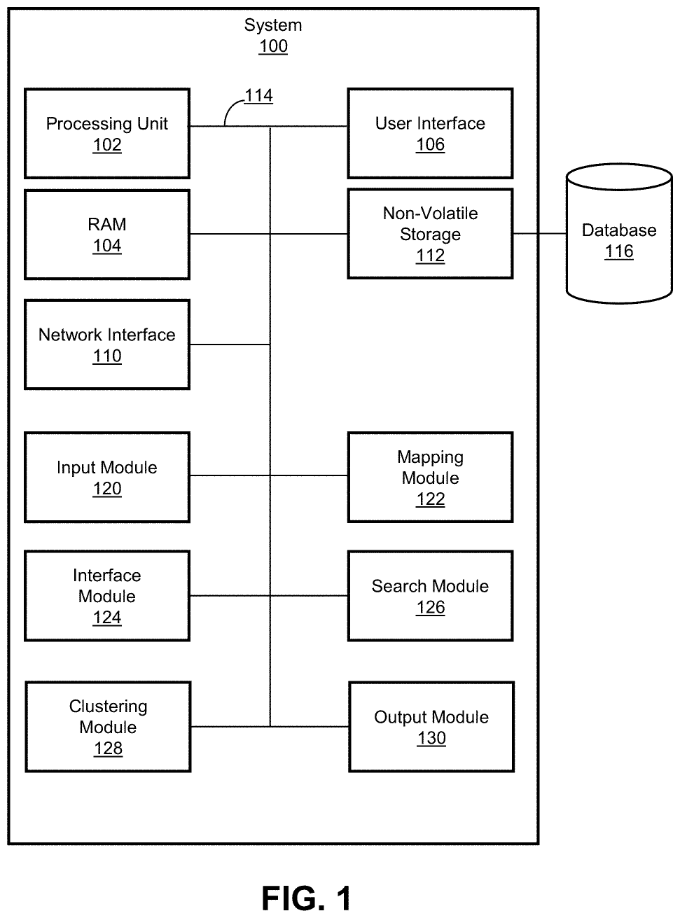

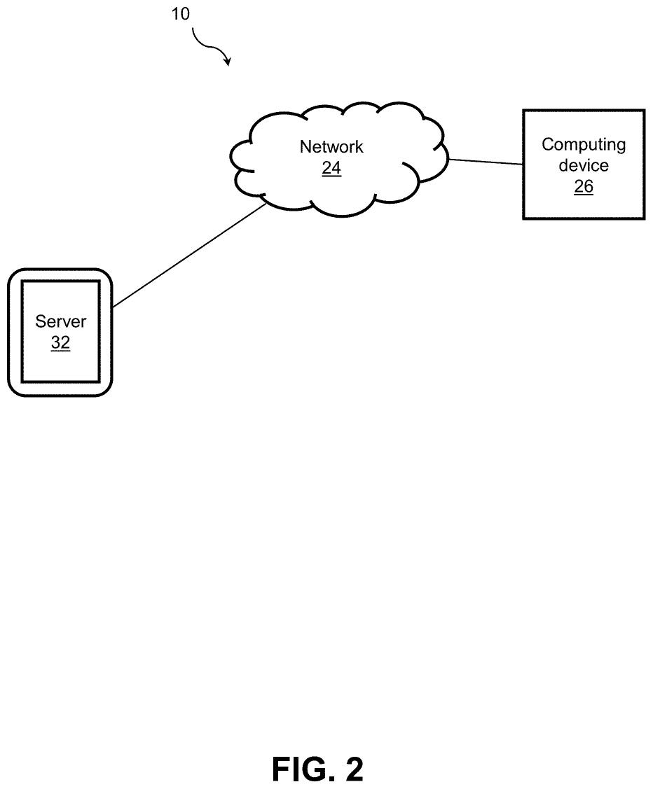

Referring now to FIG. 1 and FIG. 2, a system 100 for automatically extracting and visualizing topics and information from large unstructured text databases, in accordance with an embodiment, is shown. In this embodiment, the system 100 is run on a computing device 26 and accesses content located on a server 32 over a network 24, such as the internet. In further embodiments, the system 100 can be run only on the device 26 or only on the server 32, or run and/or distributed on any other computing device; for example, a desktop computer, a laptop computer, a smartphone, a tablet computer, a server, a smartwatch, distributed or cloud computing device(s), or the like. In some embodiments, the components of the system 100 are stored by and executed on a single computer system. In other embodiments, the components of the system 100 are distributed among two or more computer systems that may be locally or remotely distributed.

FIG. 1 shows various physical and logical components of an embodiment of the system 100. As shown, the system 100 has a number of physical and logical components, including a processing unit 102 (comprising one or more processors), random access memory (“RAM”) 104, a user interface 106, a network interface 110, non-volatile storage 112, and a local bus 114 enabling processing unit 102 to communicate with the other components. The processing unit 102 can execute or direct execution of various modules, as described below in greater detail. RAM 104 provides relatively responsive volatile storage to the processing unit 102. The user interface 106 enables a user to provide input via an input device, for example a keyboard and mouse. The user interface 106 also outputs information to output devices, for example, visualizations to a display monitor. The network interface 110 permits communication with other systems, such as other computing devices and servers remotely located from the system 100, such as for a typical cloud-based access model. Non-volatile storage 112 stores the operating system and programs, including computer-executable instructions for implementing the operating system and modules, as well as any data used by these services. Additional stored data, as described below, can be stored in a database 116. During operation of the system 100, an operating system, the modules, and the related data may be retrieved from the non-volatile storage 112 and placed in RAM 104 to facilitate execution.

The system 100 includes one or more conceptual modules configured to be executed by the processing unit 102. In an embodiment, the modules include an input module 120, a mapping module 122, an interface module 124, a search module 126, a clustering module 128, and an output module 130. In some cases, some of the modules can be run at least partially on dedicated or separate hardware. In further cases, the functions of the modules can be combined or run on other conceptual modules.

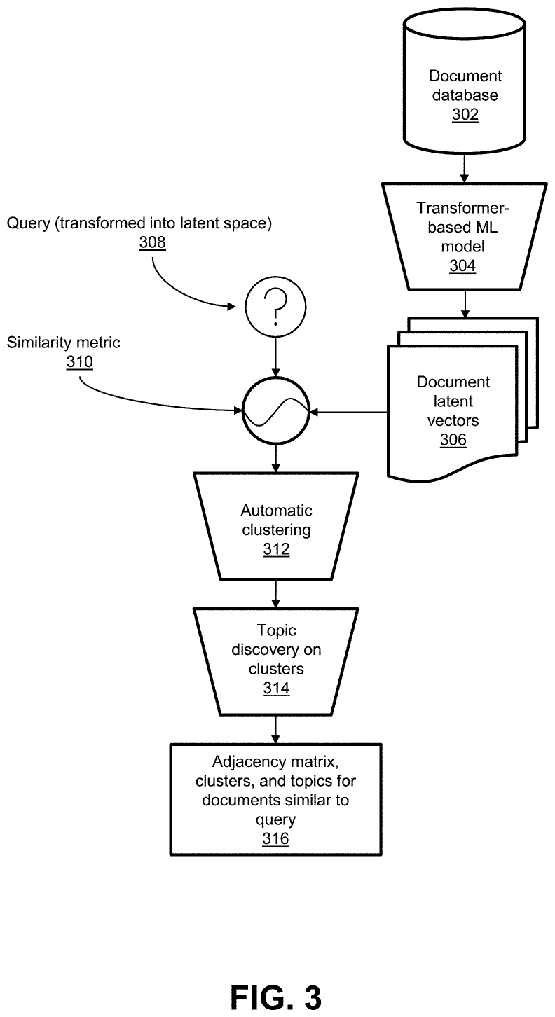

Referring now to FIG. 3, a diagrammatic flowchart is provided to illustrate, using the system 100, determining an adjacency matrix, clusters, and topics given a document database and a query that has been transformed into latent space. The document database 302 is provided and accessible to the input module 120. The database can be located on the same physical computing device in non-volatile storage 112, the database 116, or accessible on cloud infrastructure via the network interface 110. The specific documents that comprise the document database 302 are not limited by the system 100 as described herein. Rather, the input module 120 is configured to parse the documents within the document database using one or more document parsing tools, as are known to persons of skill. The ongoing development of parsing tools to parse source documents leads to further availability of the types of documents that may comprise the document database 302. The input module 120, in this case, merely requires access to the document files and access to the parsing tools in order to appropriately operate upon all of the documents in the document database 302. In examples, the document database 302 can be comprised of any suitable type of text documents; for example, emails, portable document format (PDF) documents, Word™ documents, and other plain text documents.

The mapping module 122 can use a transformer-based machine learning model 304. While we focus on “transformer-based” machine learning models in the present disclosure, we note that any model which maps from a set of words to a set of vectors would be appropriate. As such in the present disclosure, we use the term “transformer-based” machine learning model to refer to any module which maps from a set of words to a set of vectors. The various transformer-based machine learning models that may be utilized (such as the suitable configurations of layers, connections, and structures of the embodied model) would be understood by a person of skill.

Such a machine learning model can be the encoding portion of a pretrained transformer model. In some cases, the transformer-based machine learning model 304 can be fine-tuned for specific document databases. The document latent vectors 306 are determined by the mapping module 122 by mapping a prespecified number of words from each a transformer-based machine learning model 304 and taking an aggregate statistic (such as the mean) of the hidden state for each word. In some cases, the document latent vectors can be precomputed and stored (such as in local non-volatile storage). New latent vectors can be added to the set of document latent vectors when new documents are added to the document database 302.

A query 308, received by the interface module 124, can be any string of text that can be transformed into a latent space. The following list is a non-exhaustive list of example queries, as well as an approach for transforming said queries into the latent space:
a document title, where the title is transformed into the latent space by first searching the document database for a matching title; and if there is no match, transforming the text into the latent space using the transformer-based machine learning model;
a text document (for example, an email, portable document format (PDF) document, Word™ document, or other plain text document), where the document is transformed into the latent space by first searching the document database for a matching document; and if there is no match, transforming the document into the latent space using the transformer-based machine learning model;
a document keyword, where the keyword is transformed into the latent space by first searching the document database for a matching keyword; and if there is no match, transforming the keyword into the latent space using the transformer-based machine learning model;
a string of words related to a topic of a document, where the string of words is transformed directly into the latent space using the transformer-based machine learning model;
an author name, where the author name is transformed into the latent space by taking an aggregate statistic (such as the mean) of a latent vector of the author's previously authored documents;
a team name, where the team name is transformed into the latent space by taking an aggregate statistic (such as the mean) of a latent vector of the team's previously authored documents;
a date range, where the date is transformed into the latent space by taking an aggregate statistic measure (such as the mean) of the latent vector of other documents authored on within the query date;
and the like.

The similarity metric 310 refers to a prespecified metric for determining similarities between vectors of the same length. The similarity metric 310 could include, for example, a Euclidean distance metric, a cosine similarity metric, a Mahalanobis distance metric, and the like. The search module 126 uses the similarity metric 310 to find the documents from the document database 302 that are nearest to the query 308 using latent vectors of each document. When referring to the “documents nearest to the query”, it will be understood that this refers to the documents whose latent vectors are closest to the query 308 latent vector according to the similarity metric 310.

Given the finite set of documents nearest to the query, the clustering module 128 performs automatic clustering 312 in the latent space. Automatic clustering can be performed using, for example, k-means, Gaussian mixtures, and the like. The various clustering machine learning models that may be utilized by the clustering module 128 model (such as the suitable configurations of layers, connections, and structures of the embodied model) would be understood by a person of skill.

Automatic clustering returns a set of cluster labels to which the query 308, and the documents nearest to it, belong. With the interface module 124, the user can specify the number of the clusters. In other cases, the number of clusters can be determined automatically using, for example, Bayesian methods with sparsity inducing priors, frequentist methods with sparsity inducing regularizers, and the like, as would be appreciated by a person of skill.

Given the cluster labels and the documents nearest to the query 308, the discovery module 130 performs topic discovery on the clusters 314. Topic discovery can be performed using, for example, a generative statistical model such as a latent Dirichlet allocation (LDA), a non-negative matrix factorization, or other known methods for learning topics from the machine learning literature.

The output module 130 compiles and returns one or more of an adjacency matrix, clusters, and topics for the documents most similar to the query 308 based on the similarity metric 310. In some cases, this output can be stored in non-volatile storage 112 or the database 116 for future use; such as in the case of common queries or can be recomputed on the fly.

The output module 130 may return the adjacency matrix, clusters, and topics in the same form as the query. For example, if the query was in the form of a document title, the adjacency matrix, clusters, and topics can be returned for the documents whose title is nearest the document title query. In another example, if the query was in the form of an author name, the adjacency matrix, clusters, and topics can be returned for the documents whose author is nearest the author name query.

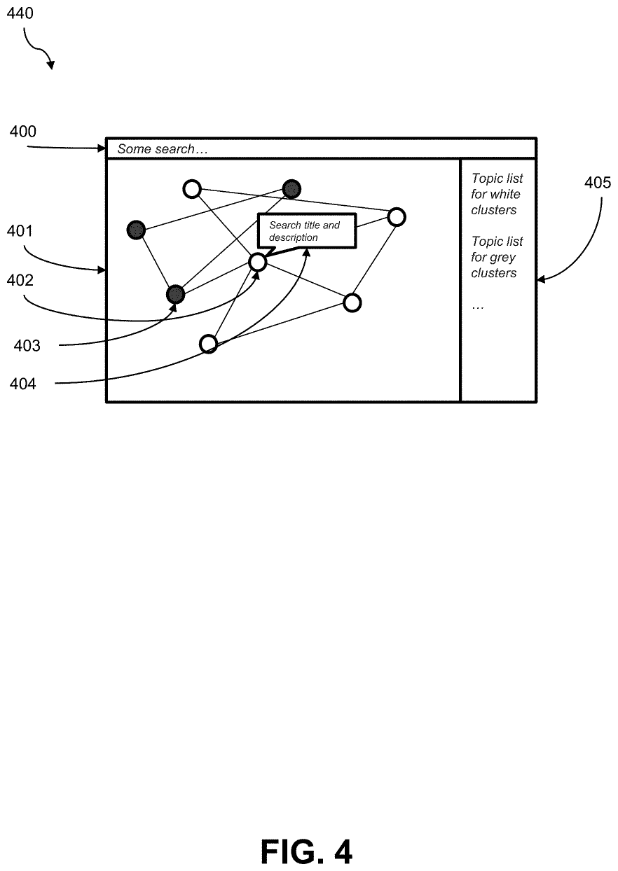

Referring now to FIG. 4, an example of a displayed user interface 440, in accordance with the present embodiments, is provided. The user interface allows a user to interact with the inputs and outputs of the system 100. Other layouts can be used having at least some of the same elements.

As illustrated, the user interface 440 includes a space to receive a user query; in this case, a search bar 400. The adjacency matrix, clusters, and topics closest to the query are returned by the output module 130. The adjacency matrix is visualized a primary window 401 of the user interface 440. Note that nodes in the adjacency matrix could be documents, authors, teams, and the like. The primary window 401 shows an example visualization using a node-graph; however, any suitable approach for visualizing adjacency matrices can be used, such as heatmaps or chord diagrams. In the example of FIG. 4, two clusters were located by the clustering module 128, but this can either be tuned by the user or automatically determined. A query node 402 was determined to be in the “white” cluster while node 403 was determined to be in the “black” cluster. In some cases, hovering over or clicking on a node could provide a description of the node 404. Topics discovered for each cluster can be listed in a secondary pane 405.

For clarity, the adjacency matrix defines the visualization shown in FIG. 4, including the positions of the nodes relative to one another and the connections between these nodes, as would be appreciated by a person of skill.

In further cases, other types of inputs can be received on the user interface.

The user interface can include a view toggle to allow the user to switch between different views; for example between three primary views: a document view, an author view, and an organization view. The document view can be a default view, and is illustrated in FIG. 4. This view allows the user to search through the document database more effectively. The author view is similar to the document view, where document nodes have been replaced by authors. The organization view can allow for construction of organization wide insights, such as topic coverage over time, topic coverage by team, and the like. The organization view can be different than the other two views because the primary pane can be filled with a particular visualization selected by the user and the secondary pane will be minimized.

The user interface can include an organizational view toggle. Having selected the organizational view with the view toggle, the user can choose to view a number of aggregate level visualizations that outline organization wide topic coverage. This includes, for example:
A visualization of what topics are most commonly worked on over time. One such visualization is a word cloud in which words shrink and grow given a time-slider at the bottom of the pane.
A visualization outlining topic interest by team. This can show an adjacency matrix visualization in which the nodes are high-level teams (for example, at an engineering company, this could include a systems engineering team, an electrical engineering team, a legal team, etc.). For this visualization, the right-side pane would be brought back up to display topics covered by the teams. This topic information could also be displayed as a Venn diagram.
A visualization identifying topic overlap between groups within the organization and/or external entities. One such visualization could include a Venn diagram wherein the intersecting section of the diagram shows what topics are shared between the groups.

The presently disclosed system can generate a navigable visualization using any other statistical measure that can be obtained from the computed topics for a given query, and any other visualization that can be obtained using such a statistic among the topics. The user interface can be further customized by the user.

For example, the user interface can include a number of queries slider. This slider can allow the user to specify the number of documents/authors that are returned for a single query.

In another example, the user interface can include a cluster slider. This slider can allow the user to toggle how many clusters should be computed for a current query. More clusters will mean more fine grain topics per cluster.

In yet another example, the user interface can include an option to remove overlapping topics. Topics are generally discovered for each cluster in the query group. In most cases, by default, the clustering module 128 will ensure that topics discovered for each cluster will be non-overlapping. This ensures that topic summaries are not overlapping; emphasizing the difference between clusters. However, this behaviour can be disabled by the user with this option, allowing them to see some of the similarities more clearly. This option can also allow the user to visualize the clusters in the form of a set of Venn diagrams; where overlapping topics are placed in the intersecting portion of the diagrams.

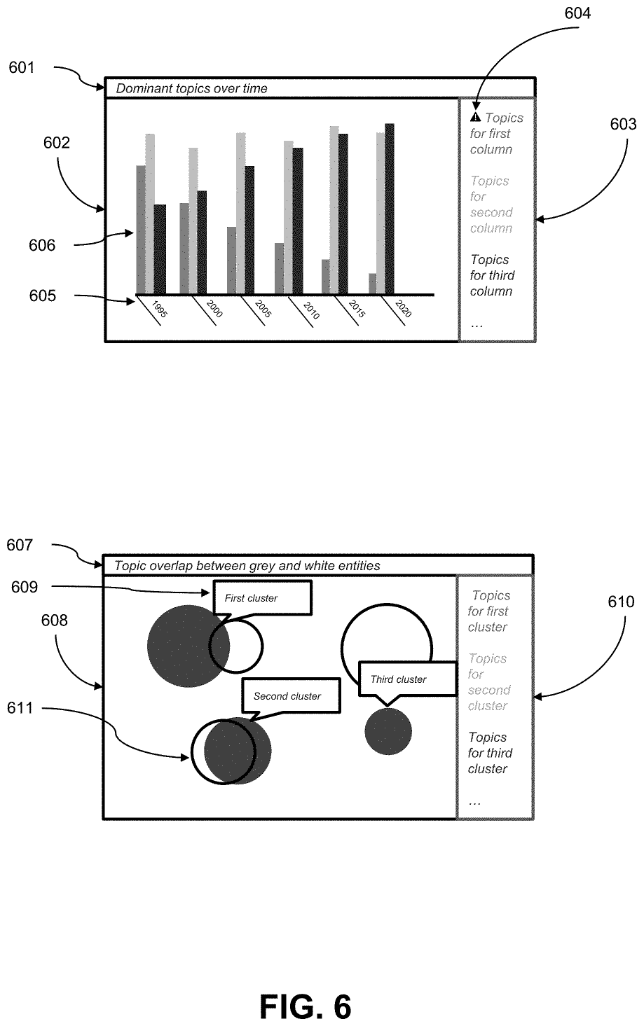

FIG. 4 provides an example of a user interface that can be generated using the system 100; however, any suitable visualization and interface arrangement can be used that takes advantage of aggregate statistics of the document database. The visualization allows the user to visualize relationships between topics and abstract queries, such as authors, teams, organizations, and the like, using plotting. FIG. 6 provides an example of some possible visualizations. These visualizations could include:
A visualization of dominant topics over time that flags topics that appear to be vanishing over time. To create this visualization, the system could cluster the entire document database in the latent space and then extract topics from each document cluster. In the case the document database is extremely large the system could sample a subset (e.g. ˜1000) of the documents from each cluster to perform topic extraction. The system could then plot the number of documents that appear in each cluster over time 602 while summarizing the topics appearing in each cluster 603. In the example provided, it becomes apparent that the number of documents in the first column is decreasing over time 605, 606. Secondary window 604 flags topics in this cluster that appear to be vanishing over time. This visualization could also be generated by replacing all document latent vectors with employee aggregate latent vectors allowing for a visualization of the number of employees working under specific topic clusters over time.
A visualization that highlights topic overlap between different teams and sectors within an organization 608. The user could input which teams/sectors they wish to compare. This visualization could be generated by clustering all documents in the database using the precomputed latent vectors. Then, for each cluster 609, the visualization could plot a circle for each team/sector under consideration whose radius is proportional to the number of documents falling into each cluster authored by the team/sector 611. The distance between circles could be proportional to the distance between the document centroids in the latent space. Each topic cluster could be summarized in the panel 610. Given access to an external entities document database. a similar visualization which highlights topic overlap between the organization and external entities, such as competitor organizations or academia would also be possible.

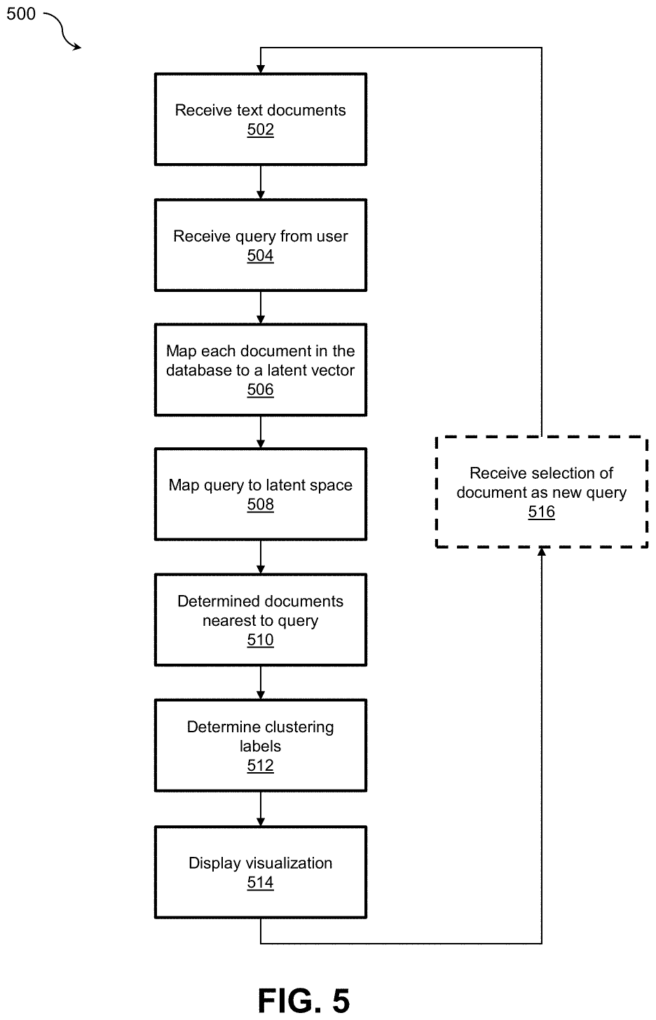

Referring now to FIG. 5, a flowchart of a method 500 for automatically extracting and visualizing topics and information from a database of unstructured text documents, in accordance with an embodiment, is shown. At block 502, the input module 120 receives or otherwise accesses unstructured text documents located on a database or memory storage. At block 504, the interface module 110 receives a query from a user. At block 506, the mapping module 122 maps each text document in the database into a latent vector in a latent space using a trained machine learning model. At block 508, the mapping module 122 maps the query to the latent space. At block 510, the search module 126 determines a predetermined set of text documents in the document database nearest to the query using a similarity metric on the latent vectors of each document. At block 512, the clustering module 128 uses a trained clustering machine learning model to determine cluster labels for the query and the set of the documents nearest to the query. Where the clustering labels are representative of topics associated with the documents that are labelled. At block 514, the output module 130 displays a visualization of the query, the documents nearest to the query, and the cluster labels; for example, as illustrated in FIG. 4.

In some cases, at block 516, the interface module 124 receives a further query from the user selecting one of the documents (i.e., a node) in the visualization. This selected document can then be used as a new query centered at this node. The selected node is now a query that is automatically transformed into the latent space and the above steps are repeated. In this way, the user can interactively explore their document database. Note that the above steps can be applied when documents are replaced with authors, teams, organizations, and the like.

The vast majority of other topic modeling approaches use induction; meaning they use a vast set of documents to learn a set of topics at train time, which can be queried at test time. In contrast, the present embodiments advantageously use transductive inference for topic modeling. In this way, the system 100 determines topics “lazily” or “on-the-fly”, such as only when requested by a user. The approach performed by the system 100 allows it to scale to extremely large document databases, while discovering fine-grain topics. In a particular case, transformer based text processing can be coupled with Latent Dirichlet Allocation (LDA); however, the combination of any dimensionality reduction algorithm for text coupled with any latent topic model for topic discovery could be used for transductive learning applied to extract insights from unstructured text data.

The system 100 can be used in a number of useful applications. For example, the system 100 can be used for searching for a document by its topic. Engineers, lawyers, researchers, consultants and other professionals generally rely on their ability to find relevant standards, academic papers, design guides, patents, previous project documents, and the like. Generally, this process of search within an organization's own document database is limited to keyword search within a shared document folder. The system 100 can be used to find a document based on the topics covered in the document. As an example, an electrical engineer is interested in finding previous project documents related to a high-frequency antenna within their organization. They can start their search by typing in “high-frequency antenna” as a query. This query will then return a number of documents (for example, 100) that are related to the topic. Note that these documents are not explicitly required to say “high-frequency antenna” in their content. In addition to returning documents related to the search topic, the system 100 can also return a number of documents that are closely related to the search topic. For example, while the engineer may have been only interested in projects related to “high-frequency antenna” design, the system 100 may find that documents produced by teams working on heat sinks were using similar iterative design approaches as those working on high-frequency antenna. In some cases, the documents returned by the query will be automatically clustered and their topics discovered and high-lighted in the right-side pane for easier parsing.

In another example, the system 100 can be used for searching for project collaborators based on their expertise. Finding collaborators within an organization, especially as a new hire, can be challenging. Often a key role of an effective manger is to help identify those within the organization that have expertise in tackling the problems of a specific project. Returning to the example of an electrical engineer working on a project related to “high-frequency antenna”, consider the following scenario: the engineer has run into a problem in the project for which their education and textbooks do not provide a satisfactory answer. Like many problems in engineering, this specific problem requires tacit knowledge of the task at hand. Generally, the engineer will likely have to ask around the organization to find someone who has expertise with such a problem. Advantageously, the system 100 can be used to find collaborators that have worked on topics directly related to the problem at hand. The user can input “high-frequency antenna” as a query, but this time they change to the “author explorer” view, as described above. This essentially replaces documents with authors in the primary window. The user will find a number of authors that worked on the topic based on their uploads into the organizations document database. In addition, the system 100 can return a number of potential collaborators that have worked on topics that are closely adjacent to the query topic of interest. Similar to the document search, the authors will be automatically clustered and their topics discovered and highlighted in the right-side pane for easier parsing. Advantageously, the system 100 allows the engineer to search for collaborators outside of their local sphere, taking full advantage of the organization's talent and experience.

In another example, the system 100 can be used for building more effective integrated project teams that better account for team experience. At the start of a new project, managers are often tasked with building an effective team whose expertise matches the task at hand. In this example, imagine a project manager that is new to the company who is tasked with building a new product. They may start the team building process by listing out the skills they believe relevant and then ask around or discuss with superiors to build an integrated project team. Rather than having to rely on tribal knowledge of employee expertise, the manager can instead input the list of skills they deem relevant to the project as a query and switch to author view. This will show a list of individuals who have worked on the search topics listed in some capacity. The authors will be automatically clustered and their topics discovered and highlighted in the right-side pane for easier parsing. Again, these topics do not need to explicitly appear in the documents the employees have worked on. Instead, employees returned by the query need only to have worked on documents with semantically similar topics.

In another example, the system 100 can be used for hiring team members after talent loss. Talent turnover is a challenging problem for many organizations and hiring new team members without losing organizational expertise is extremely challenging. Often job posts will be designed to attract an individual that can fill the gap of a recently retired or recently moved-on employee. Rather than having to guess what that employee brought to the organization, the system 100 can be used to allow hiring managers to determine what topics the employee tended to work on in particular. The hiring manager can input the employee's name as a query. This will query the document database for the documents produced by the employee as well as the documents that are semantically similar to the document's produced by the employee. The documents generated by the employee, as well as documents semantically similar to those generated by the employee, will be automatically clustered and their topics displayed and highlighted in the right-side pane for easier parsing. The hiring manager can then use this information to build a more effective job posting that can better fill the gap left by the employee.

In another example, the system 100 can be used for pre-emptively hiring team members based on vanishing skills. An effective hiring manager pre-emptively begins hiring talent before a skill gap negatively impacts a project. The system 100 can be used to identify potential gaps in an organization's expertise over time. The hiring manager can switch to the organization explorer to determine what topics are commonly worked on over time. In some cases, some topics will appear to grow and shrink in the visualization. The hiring manager can then note down what topics appear to be vanishing. The hiring manager can input these topics as a query and switch to the author view. From here, the hiring manager can identify potential reasons for why employees are no longer working on these topics. If deemed necessary, the hiring manager can pre-emptively hire employees whose skillset will see the organization producing more work on these topics in the future.

In another example, the system 100 can be used for tracking organizational topic interest over time. For organizational leaders, it can be valuable to track what topics are being worked on at the organization level. For example, a technology company executive may know that their competitors are increasing their efforts in developing high-frequency antenna. They may send a memo out to the organization leadership to increase efforts in that area due to competitive pressure. Later, they can use the organization explorer visualization. If the organization leadership has been successful, they should expect to see documents with topics related to high-frequency antenna being more frequently authored over time. Alternatively, perhaps they see that topic interest in high-frequency antenna was less than they had hoped, leaving them vulnerable to their competition. They can use the organizational view to examine if certain teams are doing better than others at working on this topic; opening the door for more targeted conversations with organization leadership.

In another example, the system 100 can be used for identifying topic overlap between an organization and an external entity. It is particularly important for organizations to stay aligned with the topics of interest of external entities. This can be for the purpose of staying up to date with the competition, their customers, and academia. In an example, an organization leader may want to confirm their technology company is staying up to date with the latest in high-frequency antenna research. The leader switches to the organization view of the visualization and run a comparison between their document database and a database of academic papers. The system 100 can generate a visualization of the non-overlapping and intersecting topics between the two databases. This can be in the form of a Venn diagram, a color-coded word cloud, and the like. From this visualization, the organization leader can determine which topics they should be investing in more to stay up to date with the latest in academic research.

Although the invention has been described with reference to certain specific embodiments, various modifications thereof will be apparent to those skilled in the art without departing from the spirit and scope of the invention as outlined in the claims appended hereto.

1. A computer-implemented method for automatically extracting and visualizing topics and information from a database of text documents, the method comprising:
mapping each text document in the database into a latent vector in a latent space using a machine learning model;
receiving a query from a user;
mapping the query to the latent space;
retrieving a predetermined number of text documents in the document database nearest to the query using a similarity metric on the latent vectors of each document;
using a clustering machine learning model, clustering the retrieved documents and determining cluster labels that are representative of topics for both the query and the set of the documents nearest to the query; and
displaying a visualization of the query, the documents nearest to the query, and the cluster labels.

2. The method of claim 1, wherein each text document in the database is mapped into a latent vector using a transformer-based machine learning model and taking an aggregate of a hidden state for each word.

3. The method of claim 2, wherein the aggregate is given by any statistic of the latent vectors.

4. The method of claim 1, wherein the number of clusters is determined using frequentist or Bayesian techniques.

5. The method of claim 1, wherein the number of clusters is received from the user.

6. The method of claim 1, wherein the topics are determined from the cluster labels using latent Dirichlet allocation or non-negative matrix factorization.

7. The method of claim 1, wherein topics are extracted over only a subset of the document database, the subset being a particular number of documents nearest to the query.

8. The method of claim 1, wherein each document in the database has an author or team associated with the document, the method further comprising determining an aggregate measure of the latent vectors of the documents associated with the author or team.

9. The method of claim 1, wherein the visualization is of an adjacency matrix with the documents nearest to the query are centered around the query.

10. The method of claim 1, further comprising receiving a further query from the user in regard to one of the documents in the visualization, replacing the query with the further query and reperforming the method from the mapping step.

11. A system for automatically extracting and visualizing topics and information from a database of unstructured text documents, the system comprising one or more processors in communication with a data storage, the one or more processors configured to execute:
an interface module to receive a query from a user;
a mapping module to map each text document in the database into a latent vector in a latent space using a trained machine learning model, and to map the query to the latent space;
a search module to determine a predetermined set of text documents in the document database nearest to the query using a similarity metric on the latent vectors of each document;
a clustering module to use a trained clustering machine learning model to cluster the retrieved documents and determine cluster labels that are representative of topics for both the query and the set of the documents nearest to the query; and
an output module to display a visualization of the query, the documents nearest to the query, and the cluster labels.

12. The system of claim 11, wherein each text document in the database is mapped into a latent vector using a transformer-based machine learning model and taking an aggregate of a hidden state for each word.

13. The system of claim 12, wherein the aggregate is given by any statistic of the latent vectors.

14. The system of claim 11, wherein the number of clusters is determined using frequentist or Bayesian techniques.

15. The system of claim 11, wherein the number of clusters is received from the user.

16. The system of claim 11, wherein the topics are determined from the cluster labels using latent Dirichlet allocation or non-negative matrix factorization.

17. The system of claim 11, wherein topics are extracted over only a subset of the document database, the subset being a particular number of documents nearest to the query.

18. The system of claim 11, wherein each document in the database has an author or team associated with the document, and wherein the mapping module further determines an aggregate measure of the latent vectors of the documents associated with the author or team.

19. The system of claim 11, wherein the visualization is an adjacency matrix with the documents nearest to the query are centered around the query.

20. The system of claim 11, wherein the interface module receives a further query from the user of one of the documents in the visualization, the system configured to regenerate the visualization on the basis of the further query.
